(19) United States
(12) Patent Application Publication
(10) Pub. No.: US 2016/0188129 A1
(43) Pub. Date: Jun. 30, 2016

(54) ELECTRONIC DEVICE AND METHOD FOR DISPLAYING INTERFACE ACCORDING TO DETECTED TOUCH OPERATION

(71) Applicants: Fu Tai Hua Industry (Shenzhen) Co., Ltd., Shenzhen (CN); HON HAI PRECISION INDUSTRY CO., LTD., New Taipei (TW)

(72) Inventors: LI-ZHANG HUANG, New Taipei (TW); JUN FAN, Shenzhen (CN); XIAO LIU, Shenzhen (CN)

(21) Appl. No.: 14/805,083

(22) Filed: Jul. 21, 2015

(30) Foreign Application Priority Data
Dec. 25, 2014 (CN) 201410816725.8

(51) Int. Cl. G06F 3/0482; G06F 3/0484; G06F 3/0488; G06F 3/041

(52) U.S. Cl. CPC G06F 3/0482; G06F 3/0416; G06F 3/04845; G06F 3/04883; G06F 2203/04104

(57) ABSTRACT

An electronic device and interface display method include a display device and a touch input device. Programs cause at least one processor to determine whether a touch on an original sidebar displayed on the display device is an extension operation or a rotation operation. An extended sidebar is displayed on the display device if the touch is the extension operation and at least one additional and rotated sidebar is displayed if the touch is determined to be a rotation operation. A sidebar which is extended, and each rotated sidebar, reveal additional application programs to a user.

### CROSS-REFERENCE TO RELATED APPLICATIONS

This application claims priority to Chinese Patent Application No. 201410816725.8 filed on Dec. 25, 2014, the contents of which are incorporated by reference herein.

### FIELD

The subject matter herein generally relates to display control.

### BACKGROUND

Electronic devices can display interfaces for a user to operate. An electronic device can display other interfaces when one interface is operated by the user.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device applying an interface display system.

FIG. 2 is a diagrammatic view of an original sidebar displayed on a display device of the electronic device of FIG. 1.

FIG. 3 is a diagrammatic view of an extended sidebar displayed on a display device of the electronic device of FIG. 1.

FIG. 4 is a diagrammatic view of an extended sidebar, showing a first rotated sidebar and a second rotated sidebar on a display device of the electronic device of FIG. 1.

FIG. 5 is a diagrammatic view of the original sidebar, when a touch mark is double clicked to retract the extended sidebar, the first rotated sidebar and second rotated sidebar on a display device of the electronic device of FIG. 1.

FIG. 6 is a flowchart of an embodiment of an interface display method for an electronic device, such as the one of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

The present disclosure is described in relation to an electronic device and interface display method. The electronic device includes a display device and an input device. Programs cause at least one processor to determine whether a certain touch on an original sidebar displayed on the display device is an extension or a rotation operation. If an extension operation is detected, an extended sidebar is displayed on the display device. If a rotation operation is detected, at least one rotated sidebar is displayed on the display device.

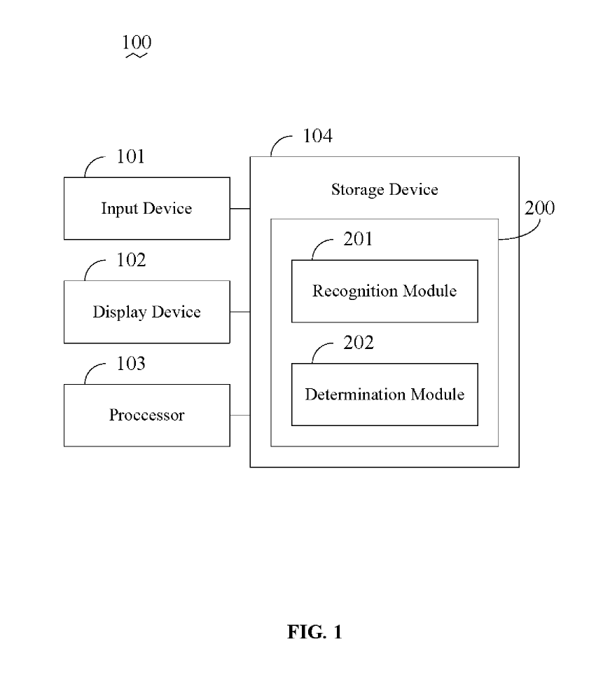

FIG. 1 illustrates an embodiment of an electronic device 100. An interface display system 200 can run in the electronic device 100. The electronic device 100 can be a mobile phone or a tablet computer, or other portable device. The electronic device 100 can include an input device 101 and a display device 102. The electronic device 102 can also include at least one processor 103 and a storage device 104. In at least one embodiment, the electronic device 100 includes one processor 103. The processor 103 executes instructions of a number of modules stored in the storage device 104. The storage device 104 can store a recognition module 201 and a determination module 202.

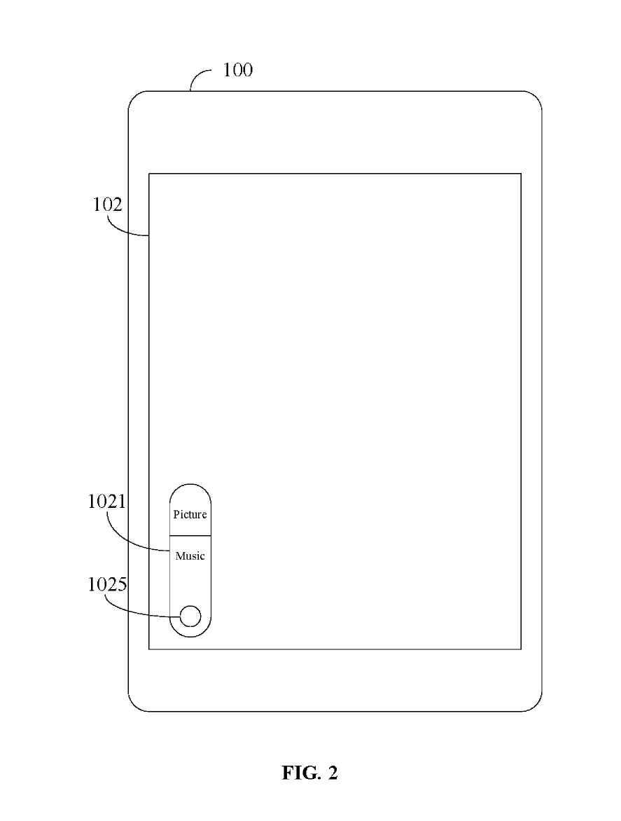

Referring to FIG. 2, the display device 102 can display an original sidebar 1021 in a refracted state. A first set of buttons are displayed on the original sidebar 1021. Each button of the first set of buttons is associated with an application program, and the application program can be activated when the corresponding button is touched by a user. In at least one embodiment, the original sidebar 1021 is displayed at a corner of the display device 102. A touch mark 1025 is also displayed at one end of the original sidebar 1021.

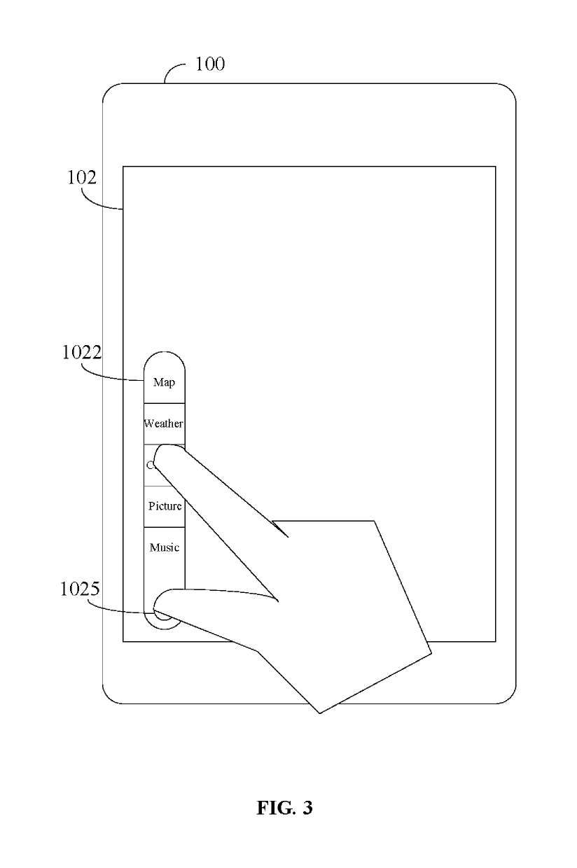

Referring to FIG. 3, the input device 101 receives a first touch on the original sidebar 1021, and the recognition module 201 determines whether the first touch is an extension operation to extend a length of the original sidebar 1021. In at least one embodiment, if the first touch includes simultaneously touching the touch mark 1025 at one end and touching the other end of the original sidebar 1021, and then sliding the other end of the original sidebar away from the touch mark 1025 so as to increase the distance between for example two fingers forming a bridge, then the recognition module 201 determines that the first touch is the extension operation. The display device 102 displays an extended sidebar 1022 to take the place of the original sidebar 1021. In at least one embodiment, the other end of the original sidebar 1021 can be slid far away from the touch mark 1025. The extended sidebar 1022 can also reveal and display a second set of buttons including the first set of buttons and at least one additional button. The touch mark 1025 is always displayed on one end of the extended sidebar 1022.

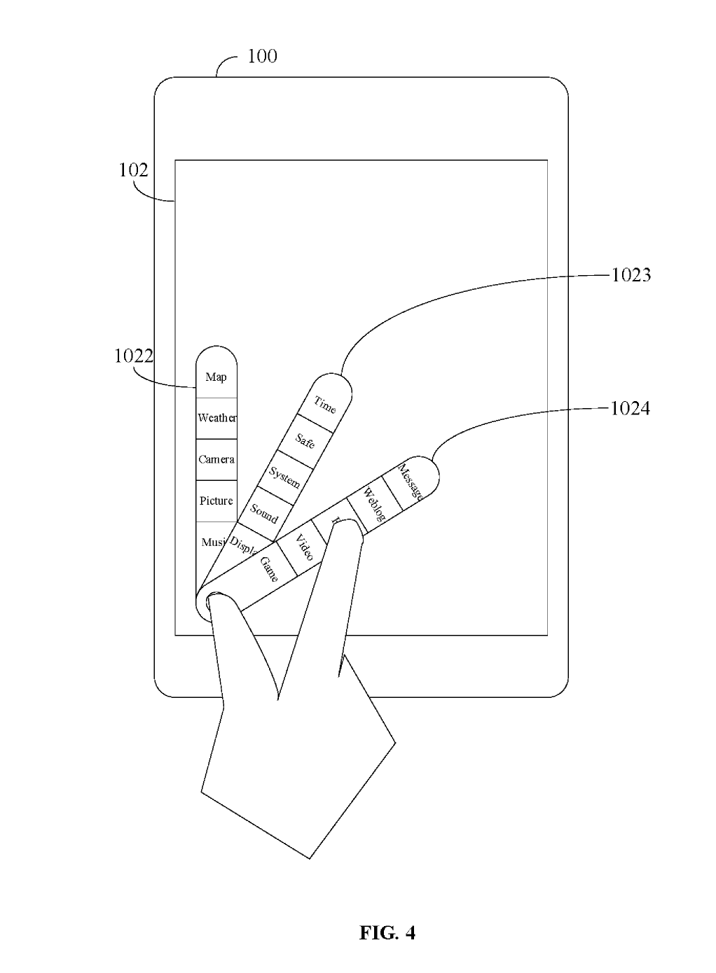

Referring to FIG. 4, the input device 101 receives a second touch on the extended sidebar 1022, and the recognition module 201 can determine whether the second touch is a rotation operation to rotate the extended sidebar 1022. In at least one embodiment, if the second touch includes a simultaneous touching of the touch mark 1025 and a touch at the other end of an extended sidebar 1022, and the other end of the extended sidebar is dragged by a fingertip for example in an arc around the touch mark 1025, then the recognition module 201 determines that such a second touch is the rotation operation.

During and after the rotation operation, the determination module 202 determines a rotation angle of the extended sidebar 1022. In at least one embodiment, the determination module 202 determines a first line along the extended sidebar 1022 and a second line between the touch mark 1025 and a point at which the current touch stops sliding direction. The determination module 202 thus determines the rotation angle between the first line and the second line.

A number of preset angle ranges are set in the electronic device 100. The determination module 202 determines which preset angle range the rotation angle is in or approximate to. In at least one embodiment, the number of preset angle ranges can include a first preset angle range which includes a number of angles smaller than or equal to a first preset angle, and a second preset angle range which includes a number of angles greater than the first preset angle. In an alternative embodiment, the number of preset angle ranges can be increased.

If the rotation angle is in the first preset angle range, the display device 102 displays the extended sidebar 1022 and a first rotated sidebar 1023. An angle between a central line of the extended sidebar 1022 and a central line of the first rotated sidebar 1023 is not greater than the first preset angle. If the rotation angle is greater and thus in the second preset angle range, the display device 102 displays the extended sidebar 1022, the first rotated sidebar 1023, and a second rotated sidebar 1024. An angle between a central line of the extended sidebar 1022 and a central line of the second rotated sidebar 1023 is at least equal to a second preset angle. In at least one embodiment, the first rotated sidebar 1023 and second rotated sidebar 1024 have same length and width as those of the extended sidebar 1022. The first rotated sidebar 1023 can include a third set of buttons which is at least partially different from the second set of buttons. The second rotated sidebar 1024 can also include a fourth set of buttons which is at least partially different from the second set of buttons and the third set of buttons.

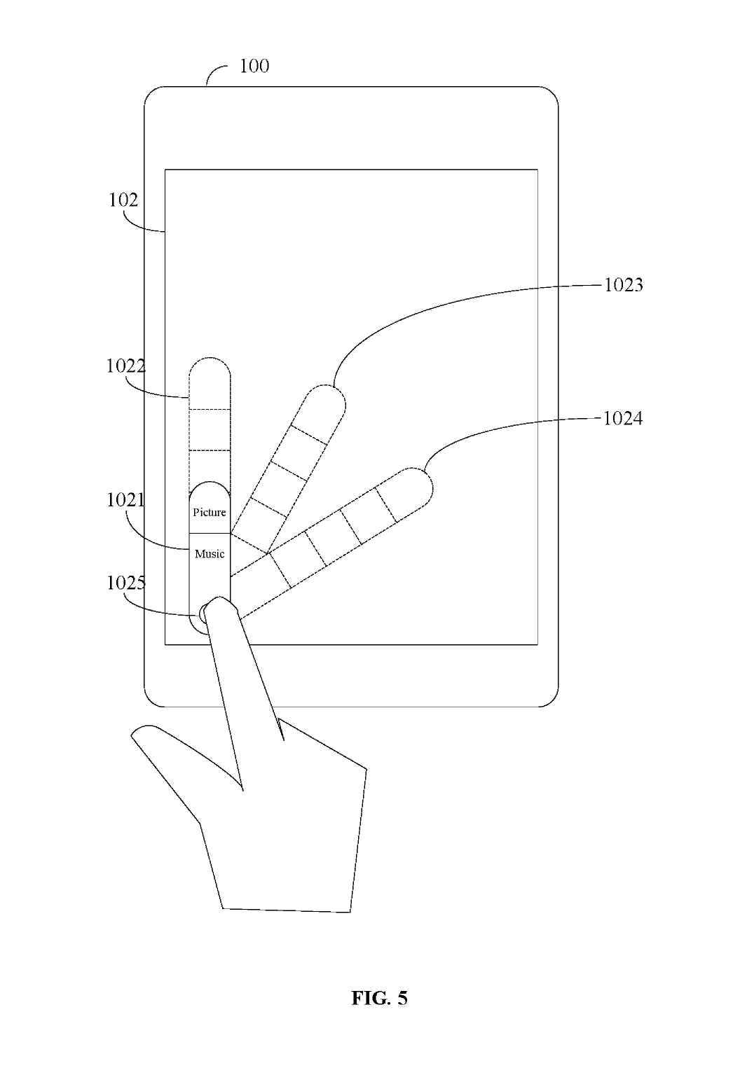

Referring to FIG. 5, the input device 101 can receive a third touch on the touch mark 1025, when only the extended sidebar 1022 is displayed, or the extended sidebar 1022, the first rotated sidebar 1023 and the second rotated sidebar 1024 are all displayed. The display device 102 then display the original sidebar 1021 in the place of the sidebar(s) as previously displayed. In at least one embodiment, the third touch can be a single top, a double click or a long press.

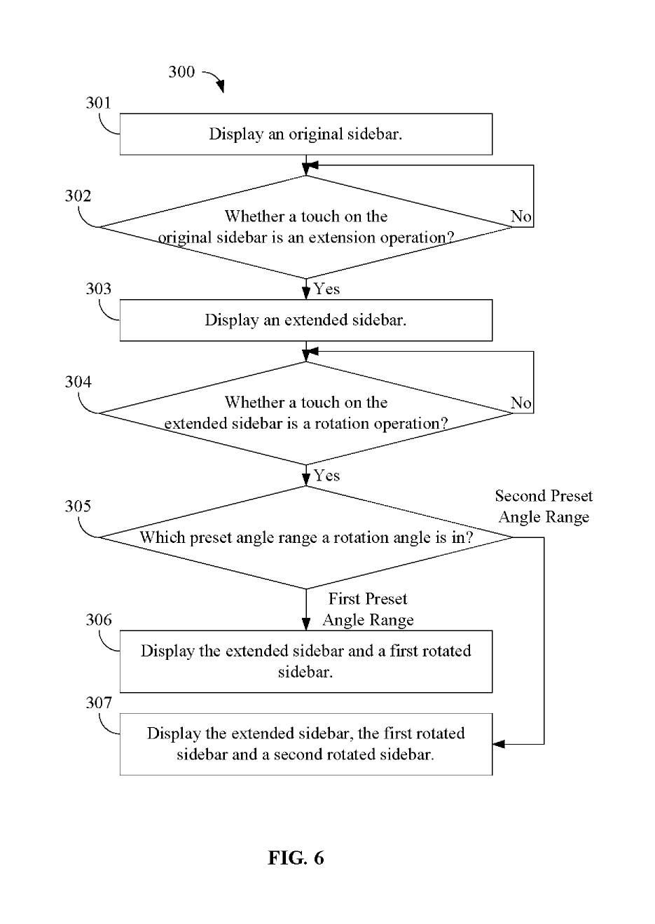

Referring to FIG. 6, a flowchart is presented in accordance with an example embodiment. A method 300 is provided by way of example, as there are varieties of ways to carry out the method. The method 300 described below can be carried out using the configurations illustrated in FIG. 1 and various elements of these figures are referenced in explaining example method 300. Each block shown in FIG. 5 represents one or more processes, methods, or subroutines, carried out in the exemplary method 300. Furthermore, the illustrated order of blocks is by example only and the order of the blocks can be changed. Additional blocks may be added or fewer blocks may be utilized, without departing from this disclosure. The exemplary method 300 can begin at block 301.

At block 301, a display device displays an original sidebar. A first set of buttons are displayed on the original sidebar in a retracted state. Each button of the first set of buttons is associated with an application program, and the application program can be activated when the corresponding button is touched. In at least one embodiment, the original sidebar is displayed at a corner of the display device and a touch mark is always displayed at one end of the original sidebar.

At block 302, an input device receives a touch on the original sidebar, and a recognition module determines whether the touch is an extension operation to extend a length of the original sidebar. If the touch is the extension operation, block 303 is implemented. If the touch is not the extension operation, block 302 is repeated. In at least one embodiment, if the touch includes simultaneously touching the touch mark at one end and touching the other end of the original sidebar, and then sliding the other end of the original sidebar straight away from the touch mark. Then the recognition module determines that the touch operation is the extension operation. In at least one embodiment, the other end of the original sidebar can be slid far away from the touch mark.

At block 303, the display device displays an extended sidebar to take the place of the original sidebar. In at least one embodiment, the extended sidebar can include a second set of the buttons. The second set of buttons includes the first set of buttons and at least one additional button.

At block 304, the input device receives a touch on the extended sidebar, and the recognition module determines whether the touch is a rotation operation to rotate the extended sidebar. If the touch is the rotation operation, block 305 is implemented. If the touch is not the rotation operation, block 304 is repeated. In at least one embodiment, if the touch includes simultaneously touching the touch mark at one end and touching the other end of the extended sidebar, and dragging the other end of the extended sidebar in an arc around the touch mark, then the recognition module determines that the touch is the rotation operation.

At block 305, a number of preset angle ranges are set in the electronic device. A determination module determines a rotation angle of the rotation operation and determines which preset angle range the rotation angle is in or approximate to. If the rotation angle is in a first preset angle range, block 306 is implemented. If the rotation angle is in a second preset angle range, block 307 is implemented. In at least one embodiment, during and after the rotation operation, the determination module determines a first line along the extended sidebar and a second line between the touch mark and a point at which the current touch stops sliding. The determination module thus determines the rotation angle between the first line and the second line. The number of preset angle ranges can include a first preset angle range which includes a number of angles smaller than or equal to a first preset angle, and the second preset angle range which includes a number of angles greater than the first preset angle. In an alternative embodiment, the number of preset angle ranges can be increased.

At block 306, the display device displays the extended sidebar and a first rotated sidebar. In at least one embodiment, an angle between a central line of the extended sidebar and a central line of the first rotated sidebar is not greater than the first preset angle. The first rotated sidebar has a same length and width as those of the extended sidebar. The first rotated sidebar can further include a third set of buttons which is at least partially different from the second set of buttons.

At block 307, the display device displays the extended sidebar, the first rotated sidebar, and a second rotated sidebar. In at least one embodiment, an angle between a central line of the extended sidebar and a central line of the second rotated sidebar is at least equal to a second preset angle which is greater than the first preset angle. The second rotated sidebar has a same length and width as those of the extended sidebar. The second rotated sidebar can further include a fourth set of buttons which is at least partially different from the second set of buttons and the third set of buttons.

The embodiments shown and described above are only examples. Many details are often found in the art such as the other features of an electronic device and method for displaying interface according to touch operation of user. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. An electronic device comprising:
a display device configured for displaying an original sidebar in a retracted state, the original sidebar comprising a first set of buttons;
an input device;
at least one processor;
a non-transitory storage device coupled to the at least one processor and storing one or more programs, which when executed by the at least one processor, cause the at least one processor to:
receive, when the original sidebar is in the retraced state, a first touch to extend a length of the original sidebar;
display, in response to the first touch, an extended sidebar comprising a second set of buttons which comprising the first set of buttons and at least one additional button;
receive a second touch to rotate the extended sidebar; and
display, in response to the second touch, the extended sidebar and at least one rotated sidebar at a non-zero angle to the original sidebar, the at least one rotated sidebar comprising a third set of buttons being at least partially different from the second set of buttons.

2. The electronic device of claim 1, wherein the first touch comprises simultaneously touching a touch mark on one end of the original sidebar and sliding the other end of the original sidebar away from the first end of the original sidebar.

3. The electronic device of claim 2, wherein the second touch comprises simultaneously touching the touch mark and the other end, and dragging the other end in an arc around the touch mark.

4. The electronic device of claim 3, wherein the one or more programs cause the at least one processor to further:
determine a rotation angle of the rotation operation;
determine which preset angle range the rotation angle is in; and
display the extended sidebar and a first rotated sidebar if the rotation angle is in a first preset angle range, wherein the first preset angle range comprises a plurality of angles smaller than or equal to a first preset angle, an angle between a central line of the first rotated sidebar and a central line of the extended sidebar is not greater than the first preset angle.

5. The electronic device of claim 4, wherein the one or more programs cause the at least one processor to further:
display the extended sidebar, the first rotated sidebar and a second rotated sidebar if the rotation angle is in a second preset angle range, wherein the second preset angle range comprises a plurality of angles greater than the first preset angle, an angle between a central line of the extended sidebar and a central line of the second rotated sidebar is at least equal to a second preset angle which is greater than the first preset angle, and the touch mark is displayed on one end of the extended sidebar, the first rotated sidebar and the second rotated sidebar.

6. The electronic device of claim 5, wherein the original sidebar comprises a first set of buttons, and the extended sidebar comprises a second set of buttons which comprising the first set of buttons and at least one additional button.

7. The electronic device of claim 5, wherein the one or more programs cause the at least one processor to further:
receive a third touch on the touch mark, wherein the third touch is a single tap, a double click or a long press; and
display the original sidebar.

8. An electronic device comprising:
a display device configured for displaying an original sidebar in a retracted state, the original sidebar comprising a first set of buttons;
an input device;
at least one processor;
a non-transitory storage device coupled to the at least one processor and storing one or more programs, which when executed by the at least one processor, cause the at least one processor to:
receive, when the original sidebar is in the retraced state, a touch to extend a length of the original sidebar; and
display, in response to the touch, an extended sidebar comprising a second set of buttons which comprising the first set of buttons and at least one additional button;

9. The electronic device of claim 8, wherein the touch comprises simultaneously touching a touch mark on one end of the original sidebar and sliding the other end of the original sidebar away from the first end of the original sidebar.

10. The electronic device of claim 9, wherein the original sidebar comprises a first set of buttons, and the extended sidebar comprises a second set of buttons which comprising the first set of buttons and at least one additional button.

11. The electronic device of claim 9, wherein the one or more programs cause the at least one processor to further:
receive a third touch on the touch mark, wherein the third touch is a single tap, a double click or a long press; and
display the original sidebar.

12. A computer-based method for displaying an interface for an electronic device being executed by at least one processor of the electronic device, the method comprising:
displaying an original sidebar in a retracted state, the original sidebar comprising a first set of buttons;
receiving, when the original sidebar is in the retracted state, a first touch to extend a length of the original sidebar;
displaying, in response to the first touch, an extended sidebar, the extended sidebar comprising a second set of buttons which comprising the first set of buttons and at least one additional button;
receiving a second touch to rotate the extended sidebar; and
displaying, in response to the second touch, the extended sidebar and at least one rotated sidebar at a non-zero angle to the original sidebar, the at least one rotated sidebar comprising a third set of buttons being at least partially different from the second set of buttons.

13. The method of claim 12, wherein in “receiving, when the original sidebar is in the retracted state, a first touch to extend a length of the original sidebar”, the first touch comprising simultaneously touching a touch mark on one end of the original sidebar and sliding the other end of the original sidebar away from the first end of the original sidebar.

14. The method of claim 13, wherein in “receiving a second touch to rotate the extended sidebar”, the second touch comprising simultaneously touching the touch mark and the other end, and dragging the other end in an arc around the touch mark.

15. The method of claim 14, wherein the method further comprising:
determining a rotation angle of the rotation operation;
determining which preset angle range the rotation angle is in; and
displaying the extended sidebar and a first rotated sidebar if the rotation angle is in a first preset angle range, wherein the first preset angle range comprises a plurality of angles smaller than or equal to a first preset angle, an angle between a central line of the first rotated sidebar and a central line of the extended sidebar is not greater than the first preset angle.

16. The method of claim 15, wherein the method further comprising:
displaying the extended sidebar, the first rotated sidebar and a second rotated sidebar if the rotation angle is in a second preset angle range, wherein the second preset angle range comprises a plurality of angles greater than the first preset angle, an angle between a central line of the extended sidebar and a central line of the second rotated sidebar is at least equal to a second preset angle which is greater than the first preset angle.

17. The method of claim 16, wherein the original sidebar comprises a first set of buttons, and the extended sidebar comprises a second set of buttons which comprising the first set of buttons and at least one additional button.
